(19) United States
(12) Patent Application Publication
(10) Pub. No.: US 2015/0368493 A1
(43) Pub. Date: Dec. 24, 2015

(54) ULTRAVIOLET CURABLE INK COMPOSITION FOR INKJET PRINTING AND PRINTING METHOD

(71) Applicant: MIMAKI ENGINEERING CO., LTD., Nagano (JP)

(72) Inventor: YUTAKA YAMADA, NAGANO (JP)

(21) Appl. No.: 14/761,309

(22) PCT Filed: Dec. 25, 2013
(86) PCT No.: PCT/JP2013/084661

§ 371 Date: Jul. 16, 2015

(30) Foreign Application Priority Data
Jan. 18, 2013 (JP) 2013-007900

(51) Int. Cl. C09D 11/38; C09D 11/101; B41J 11/00

(52) U.S. Cl. CPC C09D 11/38; B41J 11/002; C09D 11/101

(57) ABSTRACT

An object is to provide an ultraviolet curable ink composition for inkjet printing that is excellent in surface curability after printing and adhesiveness to various recording media. To achieve the object, the ink according to the present invention includes a coloring agent, a polymerizable compound that polymerizes in response to ultraviolet irradiation, a photopolymerization initiator, and a photo-initiated polymerization assistant. The photopolymerization initiator includes an α-aminoalkyl phenone-based initiator and a thioxanthone-based initiator, and the photo-initiated polymerization assistant includes a tertiary amine.

### TECHNICAL FIELD

The present invention relates to an ultraviolet curable ink composition for inkjet printing, and a printing method.

### BACKGROUND ART

Patent Document 1 describes an ink composition curable by energy beam. This ink composition contains an α-aminoalkyl phenone-based compound and a thioxanthone-based compound as photopolymerization initiators.

Patent Document 2 describes a photo-setting ink composition for use in inkjet printing. This ink composition includes, as a photopolymerization initiator, a compound that exerts an initiator function in response to light of wavelengths from 450 nm to 300 nm.

Patent Document 3 describes an LED-curable ink. This ink uses, as the photopolymerization initiators, an α-aminoalkyl phenone compound (Irg 369, Irg 379), an acylphosphine oxide compound (TPO-MAPO, Irg 819-BAPO), and dialkylamino benzophenone, and contains a tertiary amine as a photo-initiated polymerization assistant.

Patent Document 4 describes a photo-setting ink including an acylphosphine oxide-based photopolymerization initiator, a thioxanthone-based photopolymerization initiator, and/or an aminoalkyl phenone-based photopolymerization initiator.

Patent Literatures 5 and 6 each describe an ink set for inkjet recording containing a thioxanthone-based photopolymerization initiator.

### PRIOR ART DOCUMENT

### Patent Document

Patent Document 1: Japanese Laid-Open Patent Application No. 2009-275175 A (disclosed on Nov. 26, 2009)

Patent Document 2: Japanese Laid-Open Patent Application No. 2009-35650 A (disclosed on Feb. 19, 2009)

Patent Document 3: Japanese Laid-Open Patent Application No. 2010-150465 A (disclosed on Jul. 8, 2010)

Patent Document 4: Japanese Laid-Open Patent Application No. 2012-126122 A (disclosed on Jul. 5, 2012)

Patent Document 5: Japanese Laid-Open Patent Application No. 2012-140492 A (disclosed on Jul. 26, 2012)

Patent Document 6: Japanese Laid-Open Patent Application No. 2012-140493 A (disclosed on Jul. 26, 2012)

### SUMMARY OF THE INVENTION

### Problem to be Solved by the Invention

However, the above-described inks are insufficient in surface curability after printing and adhesiveness to recording media. Particularly, when a long-wavelength LED is used as a light source of ultraviolet for irradiation to cure the ink, tackiness of the cured film is poor and abrasion resistance is insufficient because of insufficient curing of the surface.

The present invention was accomplished in view of such circumstances, and provides an ultraviolet curable ink composition for inkjet printing that is excellent in surface curability after printing and adhesiveness to various recording media.

### Solution to the Problem

An ultraviolet curable ink composition for inkjet printing according to the present invention includes a coloring agent, a polymerizable compound that polymerizes in response to ultraviolet irradiation, a photopolymerization initiator, and a photo-initiated polymerization assistant. The photopolymerization initiator includes an α-aminoalkyl phenone-based initiator and a thioxanthone-based initiator, and the photo-initiated polymerization assistant includes a tertiary amine.

The ultraviolet curable ink composition for inkjet printing according to the present invention includes the photopolymerizable compound and the photo-initiated polymerization assistant together, and thus is excellent in surface curability and adhesiveness to various recording media. Particularly, even when a light emitting diode is used as an ultraviolet light source of which emission lines have long wavelengths of 350 nm or more and 420 nm or less, the surface can be cured sufficiently.

In the ultraviolet curable ink composition for inkjet printing according to the present invention, the α-aminoalkyl phenone-based initiator is more preferably at least one of 2-benzyl-2-dimethylamino-1-(4-morpholinophenyl)-butanone-1, and 2-dimethylamino-2-(4-methyl-benzyl)-1-(4-morpholine-4-yl-phenyl)-butane-1-one. These polymerization initiators are readily available.

In the ultraviolet curable ink composition for inkjet printing according to the present invention, the tertiary amine is more preferably an aromatic tertiary amine. Adhesiveness to recording media further improves.

In the ultraviolet curable ink composition for inkjet printing according to the present invention, the polymerizable compound more preferably contains a monofunctional monomer having an acrylic group or a vinyl group by 65 wt. % or more for a whole quantity of the polymerizable compound. Adhesiveness to recording media further improves.

The ultraviolet curable ink composition for inkjet printing according to the present invention more preferably contains the monofunctional monomer by 75 wt. % or more for a whole quantity of the polymerizable compound. Adhesiveness to recording media remarkably improves.

In the ultraviolet curable ink composition for inkjet printing according to the present invention, the monofunctional monomer preferably includes N-vinylcaprolactam, tetrahydrofurfuryl acrylate, and ethoxy ethoxyethyl acrylate, and a total content of N-vinylcaprolactam, tetrahydrofurfuryl acrylate, and ethoxy ethoxyethyl acrylate is 35 wt. % or more and 50 wt. % or less for a whole quantity of the monofunctional monomer.

These three monofunctional monomers are contained in the range of 35 wt. % or more and 50 wt. % or less for a whole quantity of the monofunctional monomer, and thus a good image quality can be obtained while good adhesiveness to polyvinyl chloride and polycarbonate is ensured. That is, these three monofunctional monomers have low viscosity and high solubility for plastic; however, even when plastic is used as a recording medium, the content of these three monofunctional monomers in the above-described range prevents the ink from eroding the plastic. For this reason, degradation of image quality and blanching in the case of transparent plastic can be prevented.

In the ultraviolet curable ink composition for inkjet printing according to the present invention, the monofunctional monomer more preferably includes isobornyl acrylate by 25 wt. % or more and 40 wt. % or less for a whole quantity of the monofunctional monomer.

Isobornyl acrylate has a high Tg of homopolymer, and a higher content of isobornyl acrylate improves tackiness of a cured film and lowers its transferability. In addition, isobornyl acrylate has low erosiveness to plastic. However, even when recording media such as polyvinyl chloride and polycarbonate that exert adhesiveness through erosion by the ink are used, a content of 40 wt. % or less of isobornyl acrylate provides good adhesiveness to the recording media.

A printing method according to the present invention includes: discharging the ultraviolet curable ink composition for inkjet printing according to the present invention onto a recording medium; and using, as an ultraviolet light source, a light emitting diode of which emission lines have wavelengths of 350 nm or more and 420 nm or less to perform light irradiation on the ultraviolet curable ink composition for inkjet printing discharged onto the recording medium.

The ultraviolet curable ink composition for inkjet printing according to the present invention also cures well by ultraviolet of long wavelengths of 350 nm or more and 420 nm or less. Therefore, a print excellent in tackiness and abrasion resistance can be obtained.

A printing method according to the present invention uses the ultraviolet curable ink composition for inkjet printing according to the present invention; and a multi-pass inkjet printing device that forms an image through scanning performed on a recording medium by a head and an ultraviolet light source.

The ultraviolet curable ink composition for inkjet printing according to the present invention is excellent in surface curability and has low curability at an interface to a recording medium. This allows the ink to erode the recording medium, and improves adhesiveness to the recording medium. In addition, the ultraviolet curable ink composition for inkjet printing according to the present invention has good surface curability of a printed thick film formed of layered thin films. This ink composition can, therefore, be used suitably in the multi-pass printing device.

The printing method according to the present invention more preferably uses a light emitting diode as the ultraviolet light source. Since long-wavelength ultraviolet emitted from the light emitting diode provides good curing, a print excellent in tackiness and abrasion resistance can be obtained.

### Effects of the Invention

The present invention exhibits an effect of excellent surface curability after printing and excellent adhesiveness to various recording media.

### EMBODIMENTS OF THE INVENTION

An embodiment of the present invention will be hereinafter described in detail.

<Ultraviolet Curable Ink Composition for Inkjet Printing>

An ultraviolet curable ink composition for inkjet printing according to the present invention (hereinafter, simply referred to as an “ink according to the present invention) includes a coloring agent, a polymerizable compound that polymerizes in response to ultraviolet irradiation, a photopolymerization initiator, and a photo-initiated polymerization assistant. The photopolymerization initiator includes an α-aminoalkyl phenone-based initiator and a thioxanthone-based initiator, and the photo-initiated polymerization assistant includes a tertiary amine.

The ultraviolet curable ink composition for inkjet printing according to the present invention includes the photopolymerizable compound and the photo-initiated polymerization assistant together, and thus is excellent in surface curability and adhesiveness to various recording media. Particularly, even when a light emitting diode of which emission lines have long wavelengths of 350 nm or more to 420 nm or less is used as an ultraviolet light source, the surface can be cured sufficiently.

[Coloring Agent]

The coloring agent included in the ink according the present invention may be selected appropriately from various coloring agents, depending on intended use. Coloring agents of various colors including yellow, cyan, magenta, and black can be used. In addition, the coloring agent may be a pigment or a dye.

The content of the coloring agent in the ink according to the present invention is not particularly limited, and may be set appropriately depending on the type of the coloring agent, the application of the ink, and the like.

[Polymerizable Compound]

The polymerizable compound included in the ink according to the present invention may be any one so long as compounds that polymerize in response to ultraviolet irradiation.

In addition, the polymerizable compound includes a monofunctional monomer having an acrylic group or a vinyl group by preferably 65 wt. % or more, and further preferably 75 wt. % or more for a whole quantity of the polymerizable compound. A content of 65 wt. % or more of the monofunctional monomer further improves adhesiveness to recording media, and a content of 75 wt. % or more of the monofunctional monomer remarkably improves adhesiveness to recording media.

Specific examples of the monofunctional monomer that may be used as the polymerizable compound include 2-hydroxyethyl acrylate, 2-hydroxypropyl acrylate, 4-hydroxybutyl acrylate, isobutyl acrylate, isooctyl acrylate, lauryl acrylate, isodecyl acrylate, 2-methoxyethyl acrylate, 3-methoxybutyl acrylate, ethoxy ethoxyethyl acrylate, trimethylolpropane formal monoacrylate, tetrahydrofurfuryl acrylate, acryloyl morpholine, N-vinylcaprolactam, N-vinylpyrrolidone, benzyl acrylate, 2-phenoxyethyl acrylate, cyclohexyl acrylate, 4-t-butylcyclohexyl acrylate, and isobornyl acrylate.

The polymerizable compound may be a polyfunctional monomer, examples of which include diethylene glycol di(meth)acrylate, dipropylene glycol di(meth)acrylate, polyethylene glycol di(meth)acrylate, 1,6-hyxanediol di(meth)acrylate, 1,6-hexanediol ethoxylate diacrylate, neopentyl glycol di(meth)acrylate, neopentyl ethoxylate glycol di(meth)acrylate, neopentyl propoxylate glycol di(meth)acrylate, bisphenol A diacrylate, dimethylol tricyclodecane diacrylate, bisphenol A propoxylate di(meth)acrylate, bisphenol A ethoxylate di(meth)acrylate, trimethylolpropane triacrylate, pentaerythritol triacrylate, trimethylolpropane ethoxylate triacrylate, trimethylolpropane propoxylate triacrylate, and pentaerythritol tetracrylate.

The polymerizable compound such as the monomers exemplified above may be used alone or in combination of more than one.

In addition, when the polymerizable compound includes three monomers of N-vinylcaprolactam, tetrahydrofurfuryl acrylate, and ethoxy ethoxyethyl acrylate, a total content of these three monomers is more preferably 35 wt. % or more and 50 wt. % or less for a whole quantity of the monofunctional monomer.

The ink composition contains these three monofunctional monomers in the range of 35 wt. % or more and 50 wt. % or less for a whole quantity of the monofunctional monomer and thus an excellent image quality can be obtained while good adhesiveness to polyvinyl chloride and polycarbonate is ensured. That is, these three monofunctional monomers have low viscosity and high solubility for plastics; however, even when plastic is used as a recording medium, the content of these three monofunctional monomers in the above-described range prevents the ink from eroding the plastic. For this reason, degradation of image quality and blanching in the case of transparent plastic can be prevented.

In addition, when the polymerizable compound includes isobornyl acrylate, isobornyl acrylate is preferably included by 25 wt. % or more and 40 wt. % or less for a whole quantity of the monofunctional monomer.

Isobornyl acrylate has a high Tg of homopolymer and a higher content of isobornyl acrylate improves tackiness of a cured film and lowers its transferability. In addition, isobornyl acrylate has low erosiveness to plastic. However, even when recording media such as polyvinyl chloride and polycarbonate that that exert adhesiveness through erosion by the ink are used, a content of 40 wt. % or less of isobornyl acrylate provides good adhesiveness to the recording media.

In addition, the content of the polymerizable compound in the ink according to the present invention is not particularly limited, and the polymerizable compound may compose the whole ink excluding a pigment, a disperse resin, the photopolymerization initiator, and an additive.

[Photopolymerization Initiator]

The photopolymerization initiator included in the ink according to the present invention includes an α-aminoalkyl phenone-based initiator and a thioxanthone-based initiator.

Specific examples of the α-aminoalkyl phenone-based initiator include 2-benzyl-2-dimethylamino-1-(4-morpholinophenyl)-butanone-1 (Irgacure 369), 2-dimethylamino-2-(4-methyl-benzyl)-1 -(4-morpholine-4-yl-phenyl)-butane-1-one (Irgacure 379), and 2-methyl-1-[-4(methylthio)phenyl]-2-morpholinopropane-one (Irgacure 907). These may be used alone or in combination of more than one. These polymerization initiators are preferable from the point of view that these polymerization initiators are readily available.

Examples of the thioxanthone-based initiator include 2,4-diethylthioxanthone, 2-isopropylthioxanthone, and 2-chlorothioxanthone.

In addition, the content of the photopolymerization initiator in the ink according to the present invention is preferably 3 wt. % or more and 15 wt. % or less, and more preferably 5 wt. % or more and 10 wt. % or less for a whole quantity of the ink.

[Photo-initiated Polymerization Assistant]

The photo-initiated polymerization assistant included in the ink according to the present invention includes a tertiary amine. The ink according to the present invention includes the photopolymerization initiator and a tertiary amine together, and thus is excellent in surface curability and adhesiveness to various recording media.

In the ink according to the present invention, the tertiary amine is more preferably an aromatic tertiary amine. Examples of the aromatic tertiary amine include p-dimethylaminobenzoic acid ethyl ester, and p-dimethylaminobenzoic acid isoamyl ester.

In addition, the content of the photo-initiated polymerization assistant in the ink according to the present invention is preferably 0.5 wt. % or more and 10 wt. % or less, and more preferably 1 wt. % or more and 5 wt. % or less for a whole quantity of the ink.

[Other Ingredients]

The ink according to the present invention may include other ingredients in addition to the coloring agent, the polymerizable compound, the photopolymerization initiator, and the photo-initiated polymerization assistant.

Examples of the other ingredients include a polymerization inhibitor added for the purpose of increasing storage stability of the ink, and a silicone-based compound added for the purpose of improving wettability on print media (recording media) and printed film performance including abrasion resistance and scratchability of a print. Examples of the polymerization inhibitor are hydroquinone, methoquinone, P-methoxyphenol, and nitrosamine salt. The polymerization inhibitor is more preferably mixed by 0.01 wt. % or more and 5 wt. % or less for a whole quantity of the ink. In addition, an example of the silicone-based compound includes polyether-modified silicone oil, and is more preferably mixed by 0.05 wt. % or more and 2 wt. % or less for a whole quantity of the ink.

[Printing Method]

A printing method according to the present invention includes: discharging the ink according to the present invention onto a recording medium; and using, as an ultraviolet light source, a light emitting diode of which emission lines have wavelengths of 350 nm or more and 420 nm or less to perform light irradiation on the ultraviolet curable ink composition for inkjet printing discharged onto the recording medium. The ink according to the present invention also cures well by ultraviolet of long wavelengths of 350 nm or more and 420 or less. Therefore, a print excellent in tackiness and abrasion resistance can be obtained.

In addition, a printing method according to the present invention uses the ink according to the present invention; and a multi-pass inkjet printing device that forms an image through scanning performed on a recording medium by a head and an ultraviolet light source. The ink according to the present invention is excellent in surface curability and has low curability at an interface to a recording medium. This allows the ink to erode the recording medium, and improves adhesiveness to the recording medium. In addition, the ink according to the present invention has good surface curability of a printed thick film formed of layered thin films. This ink can, therefore, be used suitably in the multi-pass printing device.

[Recording Medium]

The recording media applicable to the printing method according to the present invention is not particularly limited, and various media can be used as the recording media. Particularly, the ink according to the present invention is applicable to plastic recording media. Specific examples of media that can be used as the recording media include glossy vinyl chloride, polyvinyl chloride such as tarpaulin, polycarbonate, polyethylene terephthalate (PET), acrylic resins, polystyrene, polypropylene, polyethylene, and ABS resins.

[Ultraviolet Light Source]

The printing method according to the present invention more preferably uses a light emitting diode as the ultraviolet light source. Most of light emitting diodes that are currently available and emit ultraviolet are diodes that emit ultraviolet having long wavelengths of 350 nm or more to 420 nm or less. Since the ink according to the present invention can cure well by such long-wavelength ultraviolet, a print excellent in tackiness and abrasion resistance can be obtained.

The present invention is not limited to the above-described embodiment, and can be modified in various manners within the scope defined by the claims. The technical scope of the present invention also encompasses embodiments obtained by appropriately combining the technical means disclosed in the embodiment.

### EXAMPLES

The inks of examples 1 to 5 and comparative examples 1 to 4 were made according to composition shown in Table 1.

TABLE 1

| | | | | | | | Compar- | Compar- | Compar- | Compar- | Compar- |
|---|---|---|---|---|---|---|---|---|---|---|---|
| | | | | | | | ative | ative | ative | ative | ative |
| | | Exam- | Exam- | Exam- | Exam- | Exam- | exam- | exam- | exam- | exam- | exam- |
| | | ple 1 | ple 2 | ples 3 | ple 4 | ples 5 | ples 1 | ples 2 | ples 3 | ples 4 | ples 5 |
| | Proportion of | 71.6 | 71.6 | 71.6 | 78.9 | 84.2 | 89.5 | 71.6 | 71.6 | 71.6 | 78.9 |
| | monofunctional | | | | | | | | | | |
| | monomer (wt. %) | | | | | | | | | | |
| Pigment fluid | | 15 | 15 | 15 | 15 | 15 | 15 | 15 | 15 | 15 | 15 |
| dispersion | | | | | | | | | | | |
| Pigment | Pigment yellow | 3 | 3 | 3 | 3 | 3 | 3 | 3 | 3 | 3 | 3 |
| | 150 | | | | | | | | | | |
| Dispersant | Solsperse 39000 | 2 | 2 | 2 | 2 | 2 | 2 | 2 | 2 | 2 | 2 |
| | Monofunctional | 10 | 10 | 10 | 10 | 10 | 10 | 10 | 10 | 10 | 10 |
| | monomer (PEA) | | | | | | | | | | |
| Bifunctional | BPE4A | 18 | 20 | 9 | 7 | 4.5 | 18 | 18 | 18 | 18 | 9 |
| monomer | PO-NPGDA | 9 | 7 | | | | 9 | 9 | 9 | 9 | |
| | DPGDA | | | 11 | 8 | 5.5 | | | | | 11 |
| Monofunctional | V-Cap | 15 | 15 | 15 | 15 | 15 | 15 | 15 | 15 | 15 | 15 |
| monomer | THFA | 10 | 10 | 15 | 15 | 15 | 10 | 10 | 10 | 10 | 15 |
| | EOEOEA | | 5 | 5 | 8 | 10 | | | | | 5 |
| | PEA | 3 | 8 | 5 | 7 | 10 | 3 | 3 | 3 | 3 | 5 |
| | IBXA | 25 | 20 | 25 | 25 | 25 | 25 | 25 | 25 | 25 | 25 |
| | IOAA | 5 | | | | | 5 | 5 | 5 | 5 | |
| Photopolymer- | Irg369 | 4 | 4 | 4 | 4 | 5 | 5 | | | | 5 |
| ization | DETX-S | 2 | 2 | 2 | 2 | 3 | 3 | 2 | 2 | 2 | 3 |
| initiator | Irg907 | | | | 2 | | | | | | |
| | Irg918 | | | | | | | 4 | 4 | 2 | |
| | TPO | | | | | | | 6 | 4 | 2 | |
| Photo-initiated | EPA | 2 | 2 | 2 | 4 | 2 | | | | 2 | |
| polymerization | | | | | | | | | | | |
| assistant | | | | | | | | | | | |
| Additive | KF351A | 0.2 | 0.2 | 0.2 | 0.2 | 0.2 | 0.2 | 0.2 | 0.2 | 0.2 | 0.2 |
| | Methoquinone | 0.1 | 0.1 | 0.1 | 0.1 | 0.1 | 0.1 | 0.1 | 0.1 | 0.1 | 0.1 |
| Values of | Viscosity | 8.5 | 9.4 | | | | 8.9 | 9.5 | 9 | 8.7 | 10.2 |
| physical | (45° C.) | | | | | | | | | | |
| properties | Viscosity | | | 9.8 | 9.3 | 8.7 | | | | | 10.2 |
| | (30° C.) | | | | | | | | | | |
| V + TH + EO | Proportion (in | 37% | 44% | 47% | 48% | 47% | 37% | 37% | 37% | 37% | 47% |
| | monofunctional | | | | | | | | | | |
| | monomer) | | | | | | | | | | |
| IBXA | Proportion (in | 37% | 29% | 33% | 31% | 29% | 37% | 37% | 37% | 37% | 33% |
| | monofunctional | | | | | | | | | | |
| | monomer) | | | | | | | | | | |
| Tackiness of cured film | | ∘ | ∘ | ∘ | ∘ | ∘ | ∘ | Δ | Δ | ∘ | ∘ |
| Anti-ethanol rubfastness | | 40% | 40% | 40% | 30% | 30% | 40% | 20% | 20% | 30% | 40% |
| Adhesiveness | Glossy vinyl | 5 | 5 | 5 | 5 | 5 | 3 | 1 | 2 | 3 | 4 |
| | chloride | | | | | | | | | | |
| | Intermediate | 4 | 4 | 4 | 4 | 5 | 1 | 1 | 1 | 2 | 2 |
| | tarpaulin | | | | | | | | | | |
| | Polycarbonate | 4 | 5 | 5 | 5 | 5 | 2 | 1 | 1 | 2 | 4 |
| | White PET | 2 | 2 | 4 | 5 | 5 | 1 | 1 | 1 | 1 | 2 |
| | Acrylic Plate | 1 | 2 | 4 | 5 | 5 | 1 | 1 | 1 | 1 | 2 |
| | Proportion of | 71.6 | 71.6 | 71.6 | 78.9 | 84.2 | 89.5 | 71.6 | 71.6 | 71.6 | 78.9 |
| | monofunctional | | | | | | | | | | |
| | monomer (wt. %) | | | | | | | | | | |
| Pigment fluid | | 15 | 15 | 15 | 15 | 15 | 15 | 15 | 15 | 15 | 15 |
| dispersion | | | | | | | | | | | |
| Pigment | Pigment yellow | 3 | 3 | 3 | 3 | 3 | 3 | 3 | 3 | 3 | 3 |
| | 150 | | | | | | | | | | |
| Dispersant | Solsperse 39000 | 2 | 2 | 2 | 2 | 2 | 2 | 2 | 2 | 2 | 2 |
| | Monofunctional | 10 | 10 | 10 | 10 | 10 | 10 | 10 | 10 | 10 | 10 |
| | monomer (PEA) | | | | | | | | | | |
| Bifunctional | BPE4A | 18 | 20 | 9 | 7 | 4.5 | 18 | 18 | 18 | 18 | 9 |
| monomer | PO-NPGDA | 9 | 7 | | | | 9 | 9 | 9 | 9 | |
| | DPGDA | | | 11 | 8 | 5.5 | | | | | 11 |
| Monofunctional | V-Cap | 15 | 15 | 15 | 15 | 15 | 15 | 15 | 15 | 15 | 15 |
| monomer | THFA | 10 | 10 | 15 | 15 | 15 | 10 | 10 | 10 | 10 | 15 |
| | EOEOEA | | 5 | 5 | 8 | 10 | | | | | 5 |
| | PEA | 3 | 8 | 5 | 7 | 10 | 3 | 3 | 3 | 3 | 5 |
| | IBXA | 25 | 20 | 25 | 25 | 25 | 25 | 25 | 25 | 25 | 25 |
| | IOAA | 5 | | | | | 5 | 5 | 5 | 5 | |
| Photopolymer- | Irg369 | 4 | 4 | 4 | 4 | 5 | 5 | | | | 5 |
| ization | DETX-S | 2 | 2 | 2 | 2 | 3 | 3 | 2 | 2 | 2 | 3 |
| initiator | Irg907 | | | | 2 | | | | | | |
| | Irg918 | | | | | | | 4 | 4 | 2 | |
| | TPO | | | | | | | 6 | 4 | 2 | |
| Photo-initiated | EPA | 2 | 2 | 2 | 4 | 2 | | | | 2 | |
| polymerization | | | | | | | | | | | |
| assistant | | | | | | | | | | | |
| Additive | KF351A | 0.2 | 0.2 | 0.2 | 0.2 | 0.2 | 0.2 | 0.2 | 0.2 | 0.2 | 0.2 |
| | Methoquinone | 0.1 | 0.1 | 0.1 | 0.1 | 0.1 | 0.1 | 0.1 | 0.1 | 0.1 | 0.1 |
| Values of | Viscosity | 8.5 | 9.4 | | | | 8.9 | 9.5 | 9 | 8.7 | 10.2 |
| physical | (45° C.) | | | | | | | | | | |
| properties | Viscosity | | | 9.8 | 9.3 | 8.7 | | | | | 10.2 |
| | (30° C.) | | | | | | | | | | |
| V + TH + EO | Proportion (in | 37% | 44% | 47% | 48% | 47% | 37% | 37% | 37% | 37% | 47% |
| | monofunctional | | | | | | | | | | |
| | monomer) | | | | | | | | | | |
| IBXA | Proportion (in | 37% | 29% | 33% | 31% | 29% | 37% | 37% | 37% | 37% | 33% |
| | monofunctional | | | | | | | | | | |
| | monomer) | | | | | | | | | | |
| Tackiness of cured film | | ∘ | ∘ | ∘ | ∘ | ∘ | ∘ | Δ | Δ | ∘ | ∘ |
| Anti-ethanol rubfastness | | 40% | 40% | 40% | 30% | 30% | 40% | 20% | 20% | 30% | 40% |
| Adhesiveness | Glossy vinyl | 5 | 5 | 5 | 5 | 5 | 3 | 1 | 2 | 3 | 4 |
| | chloride | | | | | | | | | | |
| | Intermediate | 4 | 4 | 4 | 4 | 5 | 1 | 1 | 1 | 2 | 2 |
| | tarpaulin | | | | | | | | | | |
| | Polycarbonate | 4 | 5 | 5 | 5 | 5 | 2 | 1 | 1 | 2 | 4 |
| | White PET | 2 | 2 | 4 | 5 | 5 | 1 | 1 | 1 | 1 | 2 |
| | Acrylic Plate | 1 | 2 | 4 | 5 | 5 | 1 | 1 | 1 | 1 | 2 |

In Table 1, “BPE4A” indicates bisphenol A ethoxylate diacrylate (Miramar M240 manufactured by Miwon Specialty Chemical Co., Ltd.), “PO-NPGDA” indicates neopentyl propoxylate glycol diacrylate (Miramar M216 manufactured by Miwon Specialty Chemical Co., Ltd.), “DPGDA” indicates dipropylene glycol diacrylate (Miramar M222 manufactured by Miwon Specialty Chemical Co., Ltd.), “V-Cap indicates N-vinylcaprolactam (V-Cap manufactured by ISP Investments, Inc.), “THFA” indicates tetrahydrofurfuryl acrylate (Miramar M150 manufactured by Miwon Specialty Chemical Co., Ltd.), “EOEOEA” indicates ethoxy ethoxyethyl acrylate (Miramar M170 manufactured by Miwon Specialty Chemical Co., Ltd.), “PEA” indicates 2-phenoxyethyl acrylate (Miramar M140 manufactured by Miwon Specialty Chemical Co., Ltd.), “IBXA” indicates isobornyl acrylate (IBXA manufactured by OSAKA ORGANIC CHEMICAL INDUSTRY LTD.), “IOAA” indicates isooctyl acrylate (IOAA manufactured by OSAKA ORGANIC CHEMICAL INDUSTRY LTD.), “Irg 369” indicates 2-benzyl-2-dimethylamino-1-(4-morpholinophenyl)-butanone-1 (α-aminoalkyl phenone-based initiator manufactured by BASF Japan Ltd.), “Irg 907” indicates 2-methyl-1-(4-methylthiophenyl)-2-morpholinopropane-1-one (α-aminoalkyl phenone-based initiator manufactured by BASF Japan Ltd), “Irg 819” indicates bis(2,4,6-trimethylbenzoyl)-phenylphosphine oxide (acylphosphine oxide-based initiator manufactured by BASF Japan Ltd.), “TPO” indicates 2,4,6-trimethylbenzoyl-diphenyl-phosphine oxide (acylphosphine oxide-based initiator manufactured by BASF Japan Ltd), “DETX-S” indicates 2,4 diethylthioxanthone (KAYACURE DETX-S manufactured by Nippon Kayaku Co., Ltd.), “EPA” indicates p-dimethylaminobenzoic acid ethyl ester (KAYACURE EPA manufactured by Nippon Kayaku Co., Ltd.), and “KF351A” indicates polyether-modified silicone oil (manufactured by Shin-Etsu Chemical Co., Ltd.).

In addition, “V+TH+EO” represents a total weight percentage of V-cap, THFA, and EOEOEA.

The pigment fluid dispersion was prepared as follows. That is, 20 parts by mass of “pigment yellow 150”, 1 part by mass of “Solsperse 39000” (pigment dispersant manufactured by Lubrizol Corporation), and 79 parts by mass of phenoxyethyl acrylate were combined to reach 100 parts by mass, and these were mixed and stirred. The obtained liquid mixture was dispersed by a horizontal bead mill (with use of zirconia beads of 0.5 mm in diameter) to prepare a yellow-pigment fluid dispersion.

In addition, viscosity of the inks obtained in the examples and comparative examples were measured by a cone plate viscometer.

In addition, printing was performed on print media (recording media) with the inks of the examples and comparative examples by an inkjet printer (brand name: UJF3042, multi-pass printer equipped with UV-LED lamp, manufactured by MIMAKI ENGINEERING CO., LTD.), and adhesiveness (adhesion) of a printed film in a 100%-concentration part, tackiness of a printed film surface (tackiness of a cured film), and anti-solution rubfastness were evaluated.

A glossy white vinyl chloride sheet (“glossy vinyl chloride” in Table 1), an intermediate tarpaulin sheet, a polycarbonate sheet, a white PET sheet (“white PET” in Table 1), and an acrylic plate were used as the print media.

The adhesiveness was evaluated as follows. That is, evaluation of stripping by using cross-cut pieces of a cellophane tape (25 pieces in 2 mm-square size) was conducted to examine the number of the stripped-off pieces among the 25 pieces. Then, the evaluation was made as follows.

5: no stripped-off piece in the cross-cut test.

4: 1 to 5 stripped-off pieces in the cross-cut test.

3: 6 to 13 stripped-off pieces in the cross-cut test.

2: 14 to 19 stripped-off pieces in the cross-cut test.

1: 20 or more stripped-off pieces in the cross-cut test.

As for the tackiness of the printed films, the printed films obtained by printing on the white vinyl chloride sheets were touched with fingers, and stickiness was evaluated by the following criteria.

o: not sticky (tacky) at all

Δ: slightly sticky (tacky)

x: sticky (tacky)

The anti-solution rubfastness was evaluated as follows. Each of the printed film surfaces obtained by printing on the white PET sheets was rubbed back and forth 20 times by a swab dipped in a liquid mixture of ethanol and purified water. The highest ethanol concentration at which no rubbing mark was left on the printed film was evaluated as the anti-ethanol rubfastness.

### RESULTS

The ink including Irg 369, DETX, and EPA as in example 1 exhibited good tackiness of the printed film surface, good anti-solution rubfastness, and good adhesiveness. On the other hand, the ink of comparative example 1 not containing EPA exhibited poor adhesiveness.

In addition, the inks of comparative examples 2 and 3 respectively including Irg 819 and TPO that are the acylphosphine oxide-based initiators exhibited poor tackiness of the printed film surfaces, poor anti-solution rubfastness, and poor adhesiveness.

In addition, the ink of comparative example 4 containing the acylphosphine oxide-based initiator and the thioxanthone-based initiator together and further having an aromatic amine mixed therein exhibited poor adhesiveness.

In addition, the ink of each of the examples 3 to 5 including the monofunctional monomers by 75 wt. % or more for a whole quantity of the polymerizable compound exhibited remarkably good adhesiveness to all of the print media.

The inks that have the same monofunctional monomers as example 3 but do not include EPA exhibited poor adhesiveness.

### INDUSTRIAL APPLICABILITY

The present invention is applicable to the field of printing on various recording media.

1. An ultraviolet curable ink composition for inkjet printing, comprising:
a coloring agent;
a polymerizable compound that polymerizes in response to ultraviolet irradiation;
a photopolymerization initiator, and
a photo-initiated polymerization assistant, wherein
the photopolymerization initiator includes an α-aminoalkyl phenone-based initiator and a thioxanthone-based initiator, and
the photo-initiated polymerization assistant includes a tertiary amine.

2. The ultraviolet curable ink composition for inkjet printing according to claim 1, wherein
the α-aminoalkyl phenone-based initiator is at least one of 2-benzyl-2-dimethylamino-1-(4-morpholinophenyl)-butanone-1, and 2-dimethylamino-2-(4-methyl-benzyl)-1-(4-morpholine-4-yl-phenyl)-butane-1-one.

3. The ultraviolet curable ink composition for inkjet printing according to claim 1, wherein the tertiary amine is an aromatic tertiary amine.

4. The ultraviolet curable ink composition for inkjet printing according to claim 1, wherein
the polymerizable compound contains a monofunctional monomer having an acrylic group or a vinyl group by 65 wt. % or more for a whole quantity of the polymerizable compound.

5. The ultraviolet curable ink composition for inkjet printing according to claim 4, wherein
the monofunctional monomer is contained by 75 wt. % or more for a whole quantity of the polymerizable compound.

6. The ultraviolet curable ink composition for inkjet printing according to claim 4, wherein
the monofunctional monomer includes N-vinylcaprolactam, tetrahydrofurfuryl acrylate, and ethoxy ethoxyethyl acrylate, and
a total content of N-vinylcaprolactam, tetrahydrofurfuryl acrylate, and ethoxy ethoxyethyl acrylate is 35 wt. % or more and 50 wt. % or less for a whole quantity of the monofunctional monomer.

7. The ultraviolet curable ink composition for inkjet printing according to claim 4, wherein
the monofunctional monomer includes isobornyl acrylate by 25 wt. % or more and 40 wt. % or less for a whole quantity of the monofunctional monomer.

8. A printing method, comprising:
discharging the ultraviolet curable ink composition for inkjet printing according to claim 1 onto a recording medium; and
using a light emitting diode as an ultraviolet light source, and the light emitting diode of which emission lines have wavelengths of 350 nm or more and 420 Nm or less to perform light irradiation on the ultraviolet curable ink composition for inkjet printing discharged onto the recording medium.

9. A printing method, comprising:
using the ultraviolet curable ink composition for inkjet printing according to claim 1; and
using a multi-pass inkjet printing device that forms an image through scanning performed on a recording medium by a head and an ultraviolet light source.

10. The printing method according to claim 9, wherein
a light emitting diode is used as the ultraviolet light source.

12. The ultraviolet curable ink composition for inkjet printing according to claim 5, wherein
the monofunctional monomer includes N-vinylcaprolactam, tetrahydrofurfuryl acrylate, and ethoxy ethoxyethyl acrylate, and
a total content of N-vinylcaprolactam, tetrahydrofurfuryl acrylate, and ethoxy ethoxyethyl acrylate is 35 wt. % or more and 50 wt. % or less for a whole quantity of the monofunctional monomer.

13. The ultraviolet curable ink composition for inkjet printing according to claim 5, wherein
the monofunctional monomer includes isobornyl acrylate by 25 wt. % or more and 40 wt. % or less for a whole quantity of the monofunctional monomer.
